(19) United States
(12) Patent Application Publication
(10) Pub. No.: US 2011/0113044 A1
(43) Pub. Date: May 12, 2011

(54) SYSTEM AND METHOD FOR MANAGING SPONSORSHIP OPPORTUNITIES

(75) Inventors: Steve Baskin, Atlanta, GA (US); Yoeri Geerits, Calgary (CA); Michiel Jacobus Jannes de Haas, (US)

(73) Assignee: YAVAY, INC., Atlanta, GA (US)

(21) Appl. No.: 12/940,250

(22) Filed: Nov. 5, 2010

Related U.S. Application Data
(63) Continuation of application No. 61/258,791, filed on Nov. 6, 2009.

(51) Int. Cl. G06F 17/30

(52) U.S. Cl. 707/752; 707/E17.005; 707/E17.058

(57) ABSTRACT

The exemplary embodiments of the present invention provide a method and computer program products for managing sponsorship opportunities. The method is embodied in a computer program product for execution on an instruction processing system and includes a tangible storage medium readable by the instruction processing system and storing instructions for execution by the instruction processing system for performing the method. The method includes comparing sponsorship preferences with sponsorship properties, determining which of the sponsorship properties match all the sponsorship preferences and sorting the sponsorship properties into at least two groups, the first group including the sponsorship properties that match all the sponsorship preferences and a second group including the sponsorship properties that do not match all the sponsorship preferences. The method further includes creating a list of sponsorship properties included in the at least two groups, and transmitting the list of sponsorship properties to a user device.

### CROSS-REFERENCE TO RELATED APPLICATIONS

This application claims the benefit of U.S. Provisional Patent Application 61/253,218, filed on Nov. 6, 2009, entitled “A SYSTEM AND METHOD FOR MANAGING SPONSORSHIP OPPORTUNITIES”, which is incorporated by reference herein in its entirety.

### FIELD OF THE INVENTION

The present invention relates to a method and system for aligning a property with potential sponsor goals and needs, and more particularly, relates to a method and system for managing sponsorship opportunities.

### BACKGROUND OF THE INVENTION

To sponsor something is support an event, activity, person or organization financially, or by providing goods or services. Sponsorship is a cash/in kind fee paid to a property in return for access to an exploitable commercial potential associated with that property. A particular form of specialized brand sponsorship is where a brand sponsors an unusual event or past time that brand becomes associated with the event or past time. These sponsorships are a particular form of promotion marketing that is used to create, keep and satisfy a customer.

Currently, sponsorship opportunities are sought after by marketing departments of companies wishing to associate a product with a sponsorship opportunity. The ability to find sponsorship opportunities is very ad hoc. One can use a marketing entity that reaches out and explore us marketing opportunities with particular events and personalities. Alternatively, the entity desiring market exposure could approach event or personality himself or herself. However, up to now, there has been no systematic way to match a sponsor with a sponsorship opportunity in any methodical manner. Thus, heretofore an unaddressed need exists in the industry to address the aforementioned deficiencies.

### SUMMARY OF THE INVENTION

Embodiments of the present invention provide a system, method and computer program products for managing sponsorship opportunities.

An exemplary embodiment includes a method for managing sponsorship opportunities. The method is embodied in a computer program product for execution on an instruction processing system and includes a tangible storage medium readable by the instruction processing system and storing instructions for execution by the instruction processing system for performing the method. The method includes comparing sponsorship preferences with sponsorship properties, determining which of the sponsorship properties match all the sponsorship preferences and sorting the sponsorship properties into at least two groups, the first group including the sponsorship properties that match all the sponsorship preferences and a second group including the sponsorship properties that do not match all the sponsorship preferences. The method further includes creating a list of sponsorship properties included in the at least two groups, and transmitting the list of sponsorship properties to a user device.

A further exemplary embodiment includes a computer program product for managing sponsorship opportunities. The computer program product includes a tangible storage medium readable by a computer system and storing instructions or execution by the computer system for performing a method. The method includes comparing sponsorship preferences with sponsorship properties, determining which of the sponsorship properties match all the sponsorship preferences and sorting the sponsorship properties into at least two groups, the first group including the sponsorship properties that match all the sponsorship preferences and a second group including the sponsorship properties that do not match all the sponsorship preferences. The method further includes creating a list of sponsorship properties included in the at least two groups, and transmitting the list of sponsorship properties to a user device.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of an environment of computer systems and the remote devices utilizing the managing sponsorship opportunities system of the present invention.

FIG. 2 is a block diagram illustrating an example of a server utilizing the managing sponsorship opportunities system of the present invention, as shown in FIG. 1.

FIG. 3 is a flow chart illustrating an example of the operation of the managing sponsorship opportunities system of the present invention on the server, as shown in FIGS. 1 and 2A.

FIG. 4 is a flow chart illustrating an example of the operation of the input sponsorship process utilized by the managing sponsorship opportunities system of the present invention on the server, as shown in FIGS. 1-3.

FIG. 5 is a flow chart illustrating an example of the operation of the search sponsorship process utilized by the managing sponsorship opportunities system of the present invention, as shown in FIGS. 1-4.

### DETAILED DESCRIPTION

The invention to be described hereafter is applicable on all remote devices connected to a server hosting the managing sponsorship opportunities system in the present invention. While described below with respect to a single computer, the system and method for a managing sponsorship opportunities system is typically implemented in a networked computing environment in which a number of computing devices communicate over a local area network (LAN), over a wide area network (WAN), or over a combination of both LAN and WAN.

The managing sponsorship opportunities system, allows corporate marketers and sponsorship decision-makers to narrow their decision set to a manageable number of properties based on a number of marketing parameters. The managing sponsorship opportunities system will utilize at least two databases of information: 1) the available sponsorship property database and 2) secondary demographic and sports-related research database hereafter referred to as the demographic database. The available sponsorship property and demographic databases will provide the most efficient way to apply demographic research to align audiences of sports and entertainment events with the target audiences of corporate brands.

The available sponsorship property database contains a broad set of data that includes descriptions of a property and marketing input used to paint the most positive picture around sponsorship of the property. Within the data are data elements that help align a property with potential sponsor goals and needs.

These data elements are not exhaustive and change over time. They are captured and stored for each property in the system. Examples of these data elements include, but are not limited to the following.
Property category (Tennis, Golf, Skiing, Motorsports, etc)
Sponsorship strategy: (Awareness, Sales, Hospitality, etc)
Geographic impact: (Global, Continental, National, Regional, Local, etc)
Seasonality/timing (Months of Year)
Sponsorship levels available (Title, Main, Supplier, etc)
Sponsorship levels cost ($ Ranges)
Industry categories fulfilled by current sponsors (Beverage, Clothing, Shoes, etc)

In one embodiment, information regarding top international research organizations is examined to determine if there is opportunity or necessity in combining multiple research sources with the opportunities database to generate proper results.

The demographic database contains secondary research that indicates tendencies and interests of a geographic population. The likelihood of a particular sample population being interested in a particular event category is represented by an index.

Along with the additional information provided by the properties, the result of managing sponsorship opportunities system will rank the sponsorship opportunities that best align with the brand's goals. In one embodiment, one example of a demographic database includes, but is not limited to, MRI Profiles from MediaMark Research International (MRI), a subsidiary of GfK International. These data elements are not exhaustive and will be updated over time. In one embodiment, these data elements are imported from provider of research data, and stored for each property category in the system. Examples of these are include, but are not limited to the following.
Index (numeric score)
Population make-up
Gender (M/F)
Age (age ranges)
Income (ranges)
Net Worth (ranges)
Occupation (list)
Education
Ethnicity
Survey Categories Included
Tendencies Measured
Property Category
Index (Numeric Score)

An example of demographic data elements in an indexed form include, but are not limited to the following.
Gender: All
Household income: $75,000+
Investible assets: $150,000+
Net Worth: $500,000+
Education: College graduate
Occupation: All
Ethnicity: All
Survey Categories Included: Running, Long Distance Running, Sprinting
Tendencies Measured: Watches a running event on TV more than once a year, participates in a running event more than 3 times a year
Index: 150

An example of Index Interpretation includes, but is not limited to: A person participates heavily in running is 50% more likely to be a male with an income between $75,000 and $99,999 than other adults. This index will be compared to other sports and entertainment category indexes to determine a rank order of categories.

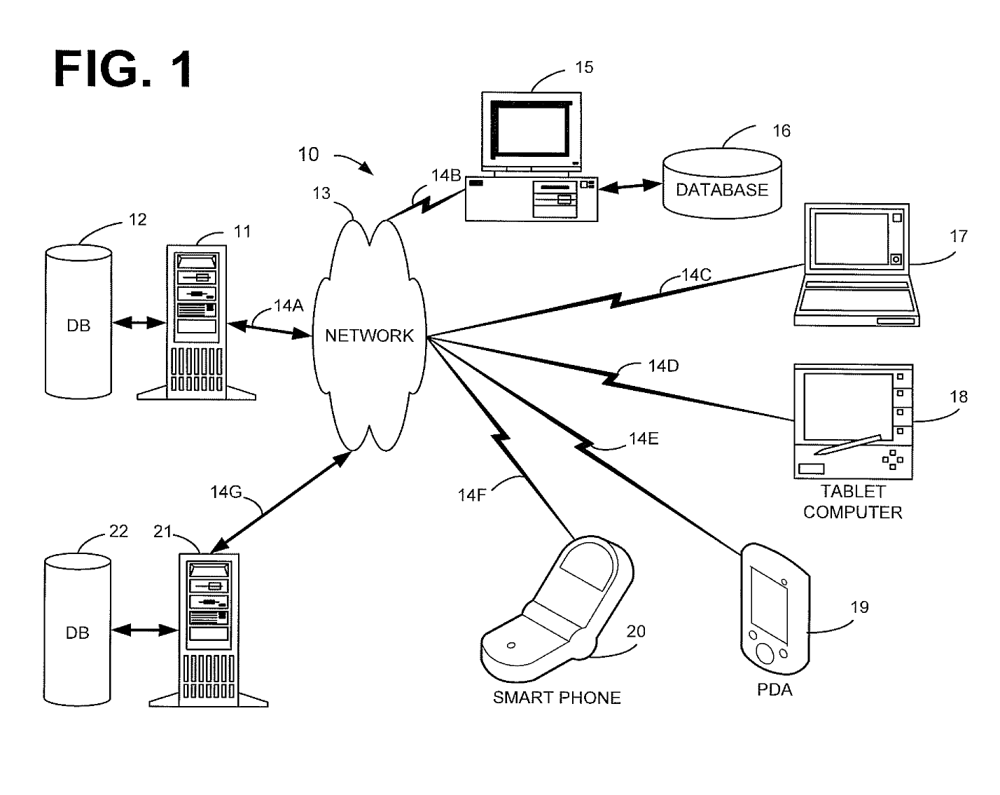

Referring now to the drawings, in which like numerals illustrate like elements throughout the several views, FIG. 1 is a block diagram illustrating an example of a managing sponsorship opportunities 10 environment including computer systems (11 and 21) and the remote devices (15, 17, 18, 19 and 20) that utilize the Managing sponsorship opportunities system of the present invention. Each remote device has applications and can have a local data store 16. Computer systems 11 and 21 contain applications, and server 11 further contains a server database 12 that is accessed by remote devices 15, and 17-20 via intermittent connections 14(A-F), respectively, over network 13. The server 11 runs administrative software for a computer network and controls access to part or all of the network and its devices. The remote devices 15 and 17-20 share the server data stored on the database 12 and may access the server 11 over a network 13 such as but not limited to; the Internet, a local area network (LAN), a wide area network (WAN), via a telephone line using a modem or other like networks. The server 11 may also be connected to the local area network (LAN) within an organization. The structure and operation of the managing sponsorship opportunities system enables the server 11 and the database 12 associated therewith to align a property with potential sponsor goals and needs.

The remote devices 15 and 17-20 may each be located at remote sites. Remote devices 15 and 17-20 include but are not limited to; PCs, workstations, laptops, PDAs, pagers, WAP devices, non-WAP devices, cell phones, palm devices and the like. Thus, when a user at one of the remote devices 15 and 17-20 desires to update the current tracking information on the data at the server 11, the remote devices 15 and 17-20 communicates over the network 13, such as but not limited to WAN, internet, or telephone lines to access the server 11.

Third party vendors' computer systems 21 and databases 22 can be accessed by the managing sponsorship opportunities server 11 in order to obtain information for the descriptions of a property and demographic data for the available sponsorship property and demographic databases. Data that is obtained from third party vendors computer system 21 and database 22 can be stored on the server 11 in order to provide later access to the user's remote devices 15 and 17-20. It is also contemplated that for certain types of data that the remote devices 15 and 17-20 can access the third-party vendor's data directly using the network 13.

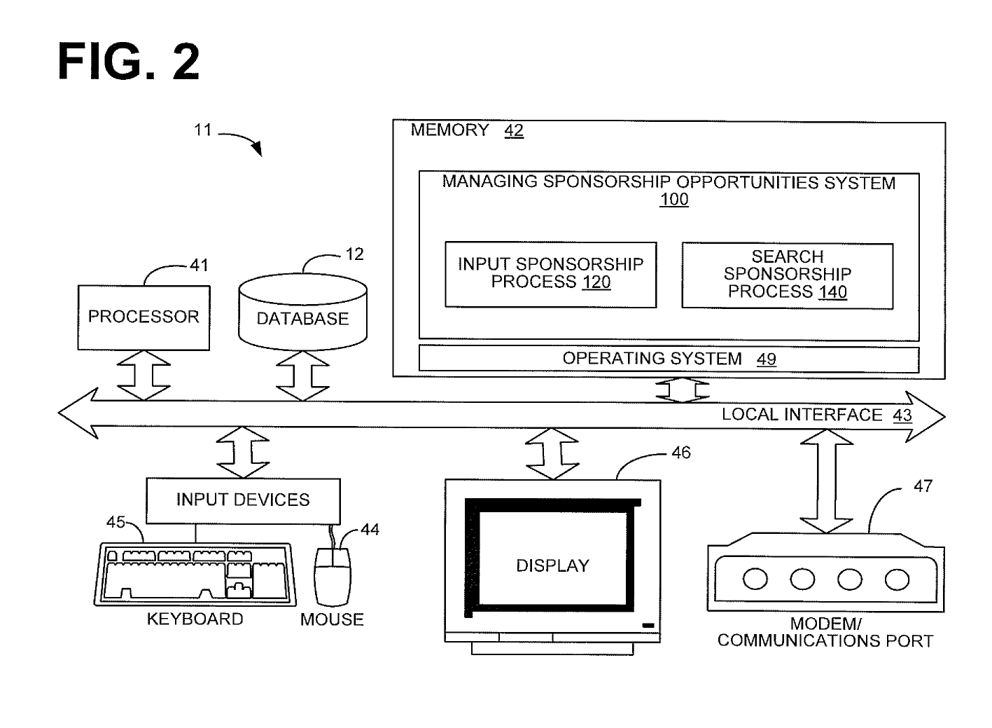

Illustrated in FIG. 2 is a block diagram demonstrating an example of a server 11, as shown in FIG. 1, utilizing the managing sponsorship opportunities system 100 of the present invention. Remote devices 15 and 17-20 include but are not limited to, PCs, workstations, laptops, PDAs, pagers, WAP devices, non-WAP devices, cell phones, palm devices and the like. The components of the remote device 15 and 17-20 are substantially similar to that of the description for the server 11 (FIG. 2). However, it is contemplated that many of the components in the user's remote devices 15 and 17-20 can be more limited in general function.

Generally, in terms of hardware architecture, as shown in FIG. 2, the computer systems 11 and 21 herein includes a processor 41, memory 42, and one or more input and/or output (I/O) devices (or peripherals), such as storage or database 12, that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom-made or commercially available processor, a central processing unit (CPU), a data signal processor (DSP) or an auxiliary processor among several processors associated with the server 10, or a semiconductor-based microprocessor (in the form of a microchip) or a macroprocessor. Examples of suitable commercially available microprocessors include, but are not limited to, the following: an 80×86 or Pentium® series microprocessor from Intel® Corporation, U.S.A., a PowerPC® microprocessor from IBM®, U.S.A., a Sparc™ microprocessor from Sun Microsystems®, Inc., a PA-RISC™ series microprocessor from Hewlett-Packard Company®, U.S.A., a 68xxx series microprocessor from Motorola Corporation®, U.S.A. or a Phenom™, Athlon™, Sempron™ or Opteron™ microprocessor from Advanced Micro Devices®, U.S.A.

The memory 42 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

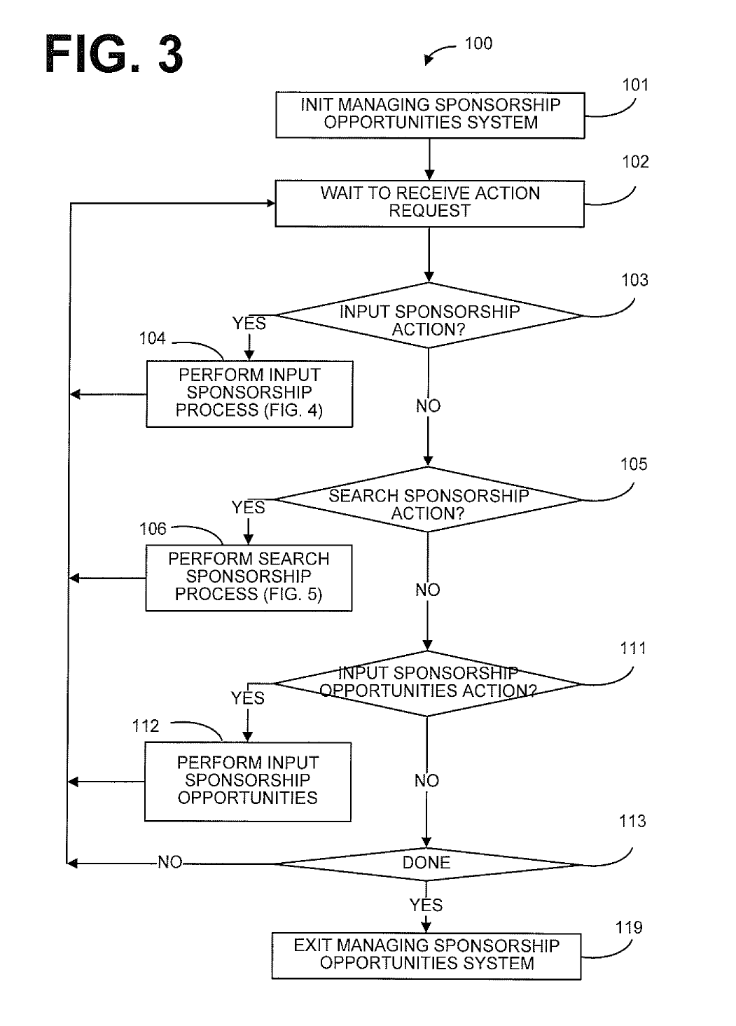

The software in memory 42 may include one or more separate programs, each of which comprises an ordered listing of executable instructions for implementing logical functions. In the example illustrated in FIG. 2, the software in the memory 42 includes, but is not limited to, a suitable operating system (O/S) 49 and the managing sponsorship opportunities system 100 of the present invention. The managing sponsorship opportunities system 100 further includes the input sponsorship process 120, and search sponsorship process 140. The software components will be described in further detail with regard to FIG. 3 through FIG. 5.

A non-exhaustive list of examples of suitable commercially available operating systems 49 is as follows (a) a Windows/Vista operating system available from Microsoft Corporation; (b) a Netware operating system available from Novell, Inc.; (c) a Macintosh/OS X operating system available from Apple Computer, Inc.; (e) an UNIX operating system, which is available for purchase from many vendors, such as but not limited to the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (such as for example Symbian OS available from Symbian, Inc., PalmOS available from Palm Computing, Inc., and Windows CE available from Microsoft Corporation).

The operating system 49 essentially controls the execution of other computer programs, such as the managing sponsorship opportunities system 100, and provides scheduling, input-output control, file and data management, memory management, and communication control and related services. However, it is contemplated by the inventors that the Managing sponsorship opportunities system 100 of the present invention is applicable on all other commercially available operating systems.

The managing sponsorship opportunities system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the managing sponsorship opportunities system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a network interface card (NIC) or modulator/demodulator 47 (for accessing other files, devices, systems, or a network), a radio frequency (RF) or other transceiver (not shown), a telephonic interface (not shown), a bridge (not shown), a router (not shown), etc.

If the computers systems 11 and 21 are a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM EEPROM or the like, so that the BIOS can be executed when the computer is activated.

When the computers systems 11 and 21 are in operation, the processor 41 is configured to execute software stored within the memory 42, to communicate data to and from the memory 42, and to generally control operations of the computer pursuant to the software. The managing sponsorship opportunities system 100 and the O/S 49 are read, in whole or in part, by the processor 41, perhaps buffered within the processor 41, and then executed.

When the managing sponsorship opportunities system 100 is implemented in software, as is shown in FIG. 2, it should be noted that the Managing sponsorship opportunities system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The Managing sponsorship opportunities system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the managing sponsorship opportunities system 100 is implemented in hardware, the managing sponsorship opportunities system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 3 is a flow chart illustrating an example of the operation of the managing sponsorship opportunities system of the present invention on the server, as shown in FIGS. 1 and 2. The managing sponsorship opportunities system of the present invention allows corporate marketers and sponsorship decision-makers to narrow their decision set to a manageable number of properties based on a number of marketing parameters. The managing sponsorship opportunities system utilizes at least two databases of information: 1) the available sponsorship property database and 2) secondary demographic and the demographic database. The available sponsorship property and demographic databases will provide the most efficient way to apply demographic research to align audiences of sports and entertainment events with the target audiences of corporate brands.

First at step 101, the managing sponsorship opportunities system 100 is initialized. This initialization includes a startup routines and processes embedded in the BIOS of the server 11. The initialization also includes the establishment of data values for particular data structures utilized in the server 11.

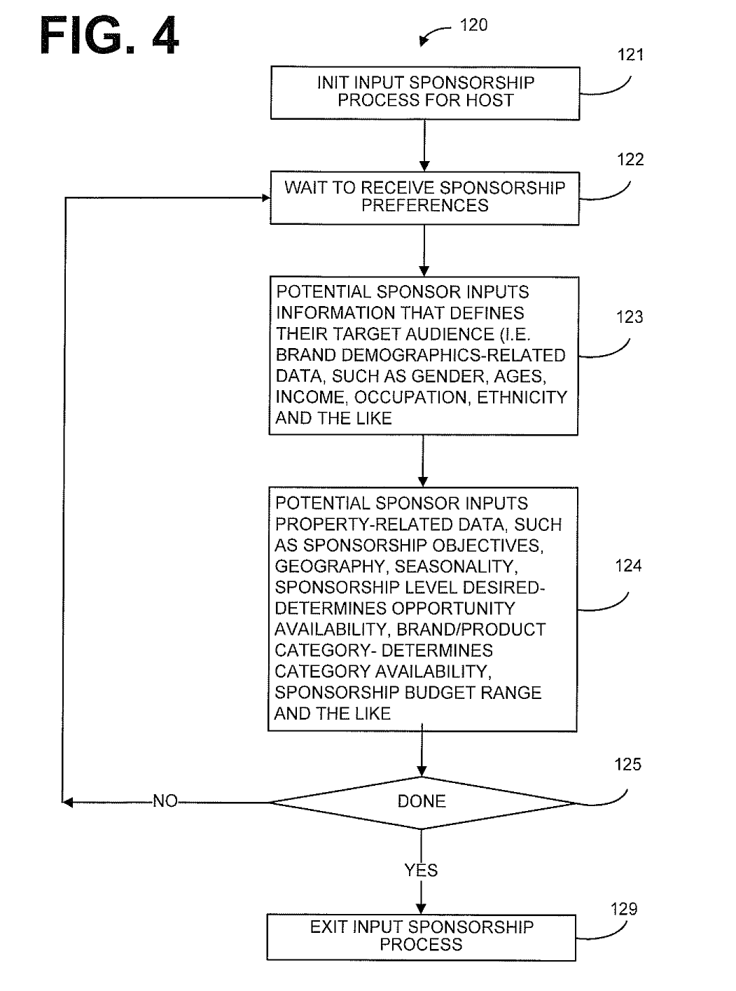

At step 102, the managing sponsorship opportunities system 100 waits to receive an action request. Once an action is received at step 102, it is determined if the action is to add a new sponsorship opportunity at step 103. If it is determined that the action is not to add a new sponsorship opportunity, then the managing sponsorship opportunities system 100 skip step 105. However, if it is determined in step 103 that a new sponsorship opportunity is to be added, then the managing sponsorship opportunities system 100 performs the input sponsorship process at step 104. The input sponsorship process is herein defined in further detail with regard to FIG. 4. After performing the input sponsorship process, the managing sponsorship opportunities system 100 returns to step 102.

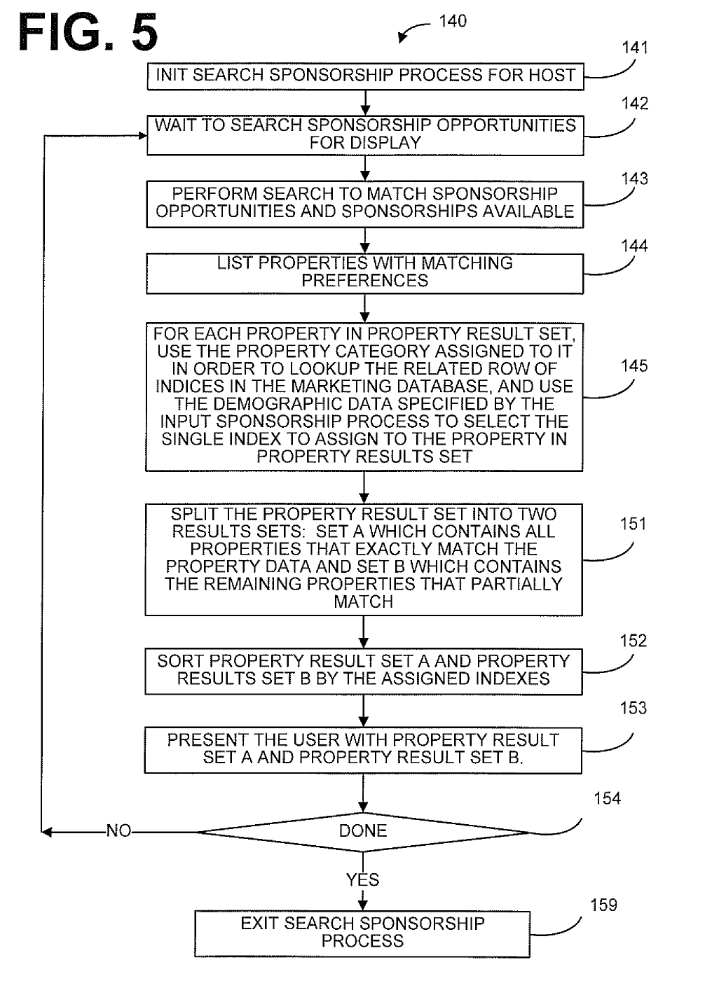

At step 105, it is determined if the action is a search sponsorship action. If it is determined that the action is not a search sponsorship action, then the managing sponsorship opportunities system 100 skip step 111. However, if it is determined in step 105 that it is a search sponsorship action, then the managing sponsorship opportunities system 100 performs the search sponsorship process at step 106. The search sponsorship process is herein defined in further detail with regard to FIG. 5. After performing the search sponsorship process, the managing sponsorship opportunities system 100 returns to step 102.

At step 111, it is determined if the action is an input sponsorship opportunities action. If it is determined that the action is not an input sponsorship opportunities action, then the managing sponsorship opportunities system 100 skip step 113. However, if it is determined at step 111 that it is an input sponsorship opportunities action, then the managing sponsorship opportunities system 100 performs the input sponsorship opportunities process at step 112. After performing the input sponsorship process, the managing sponsorship opportunities system 100 returns to step 102.

In one embodiment, the sponsorship opportunities are not exhaustive and change over time. The available sponsorship property database contains a broad set of data that includes descriptions of a property and marketing input used to paint the most positive picture around sponsorship of the property. Within the data are data elements that help align a property with potential sponsor goals and needs. The data elements are captured and stored for each property in the system. Examples of these data elements include, but are not limited to the following.
Property category (Tennis, Golf, Skiing, Motorsports, etc)
Sponsorship strategy: (Awareness, Sales, Hospitality, etc)
Geographic impact: (Global, Continental, National, Regional, Local, etc)
Seasonality/timing (Months of Year)
Sponsorship levels available (Title, Main, Supplier, etc)
Sponsorship levels cost ($ Ranges)
Industry categories fulfilled by current sponsors (Beverage, Clothing, Shoes, etc)

In one embodiment, information regarding top international sports research organizations is examined to determine if there is opportunity or necessity in combining multiple research sources with the opportunities database to generate proper results.

At step 113, it is determined if the managing sponsorship opportunities system 100 is to wait for additional action request. If it is determined at step 113 that the managing sponsorship opportunities system 100 is to wait to receive additional actions, then managing sponsorship opportunities system 100 returns to repeat steps 102 through 113. However, if it is determined at step 113 that there are no more actions to be received, then the managing sponsorship opportunities system 100 then exits at step 119.

FIG. 4 is a flow chart illustrating an example of the operation of the input sponsorship process 120 utilized by the managing sponsorship opportunities system 100 of the present invention on the server, as shown in FIGS. 1-3. The input sponsorship process 120 is utilized to input sponsor preferences that specify the demographic information that defined their target audience as well as treat the potential properties that align with the current needs and budgets. For example, the demographic information may include, but is not limited to the following types of data, brand demographics-related data and property-related data.

First at step 121, the input sponsorship process 120 is initialized on server 11. At step 122, input sponsorship process 120 waits to receive sponsorship preferences defining a sponsor's target audience. Once it is determined that a potential sponsor wishes to input preferences, then the input sponsorship process 120 enables the user to indicate brand demographics related data. The brand demographics related data includes for example, but not limited to, gender, age, income, occupation, education, ethnicity and the like, at step 123.

Next at step 124, the input sponsorship process 120 receives potential sponsor input regarding property related data. Examples of the property related data includes, but not limited to, sponsorship objectives, geography, seasonality, sponsorship level desired (i.e. determines opportunity availability), brand/product category (i.e. determines category availability), sponsorship budget range and the like.

At step 125, it is determined if there are more sponsorship preferences to be input. If it is determined at step 125 that there are more sponsorship preferences to be input, then the input sponsorship process 120 returns to repeat steps 122 through 125. However, if it is determined in step 125 that there are no more sponsorship preferences to be input, then the input sponsorship process 120 than exits at step 129.

FIG. 5 is a flow chart illustrating an example of the operation of the search sponsorship process 140 utilized by the managing sponsorship opportunities system 100 of the present invention, as shown in FIGS. 1-4. The search sponsorship process 140 enables a potential sponsor to identify which properties are the best match by referencing both the available sponsorship property database and the demographic database.

First at step 141, the search sponsorship process 140 is initialized on server 11. At step 142, the search sponsorship process 140 waits for a user to indicate a desire to search the sponsorship opportunities.

At step 143, the search sponsorship process 140 enables a user to indicate which sponsor to be matched with sponsorship opportunities. In one example, the sponsor specifies a geographic range for the property. If property is located in desired geography, property is included in selection set. The geographic ranges can be defined by the sponsor or by the managing sponsorship opportunities system. In another example, the sponsor selects the industrial sector that most closely identifies the corporate business. If no other sponsor from the same industrial sector has purchased exclusivity in that sector, property is included in selection set. The corporate/industrial sectors list can be defined by the sponsor or by the managing sponsorship opportunities system. In another example, the sponsor defines the time period in which his brand intends to purchase a sponsorship. If property has available sponsorship opportunities during that time period, property is included in selection set. In another example, the sponsor can select or narrow the selection set based on seasonality/timing. If property (typically an event in this case) does not occur within a specified date range, property is deleted from selection set. In another example, the sponsor ranks three objectives in order: Awareness, Sampling, Hospitality. Properties are scored based on its ability to deliver on prioritized objectives. In another example, the sponsor will have opportunity to define their target audience based on a limited number of demographic variables: Gender; age; income; net worth; occupation; ethnicity; home ownership; family in household. This generates an index measuring the likelihood that property's participants consist of desired sponsor demographics. Available property categories are ranked by index and can be based on best available independent market research. If sponsors budget is in a predetermined range (i.e. for example within 15 percent (+/−) of property sponsorship price), property is included in selection set. The desired sponsorship level is typically based overall availability, industrial sector/exclusivity, and budget. The sponsor is typically allowed to, but not required to, select a desired sponsorship level (i.e. Title, presenting, principal, supporting and the like). If the property does not have sponsorship opportunity available during a specified time period, property is deleted from the selection set. If the property has another sponsor from searcher's same industrial sector that has purchased or negotiated category exclusivity, property is deleted from selection set. If the property does not have a sponsorship available at the desired level within 15 percent of the sponsor's stated budget, property is deleted from the selection set.

The search sponsorship process 140 then performs a search to match sponsorship opportunities and sponsorships available by comparing the search criteria specified by the sponsor input (FIG. 4, step 124) to the property data elements associated with the properties in the available sponsorship property.

A list of properties with matching preferences is created at step 144. This list of properties contains only those properties with property data elements matching the search criteria indicated by the sponsor. It is also understood by the inventors that the matching of all sponsors looking for a sponsorship property can be matched to all sponsorship opportunities in a batch processing. This would enable a user to determine if new sponsorship opportunities have been added and that matches a sponsor looking for a sponsor property.

At step 145, the search sponsorship process 140 then compares each property in the property result set to the property category assigned to it in order to look up the related row of indices in the marketing database. The indices are created from demographic data on a particular category that indicates the likelihood of a particular demographic population to be interested in a category of properties. These indices can be created from any standardized demographic data set created from a market survey and assigned to the relevant category. Then the search sponsorship process 140 uses the demographic data specified by the sponsor input (FIG. 4, step 123) to select a single index assigned a property in the property result set.

At step 151, the property result set is split into two resulting sets. The first set contains all properties that exactly match the property data specified by the sponsor input (FIG. 4, steps 123 and 124), and the second data set which contains the remaining properties that are a partial match. At step 152, the Result Set A and the Result Set B are sorted by the assigned indexes. At step 153, the user is presented with sorted property Result Set A and sorted property Result Set B, both sorted by the assigned indexes. In one embodiment, the result set A and the result set B, comprising list of properties with matching preferences, can be displayed as output on a display 46 (FIG. 1). In an alternative embodiment, the Result Set A and the Result Set B list of properties matching preferences may be output in a printed report.

At step 154, it is determined if there are more objects to be configured. If it is determined at step 154 that there are more sponsorship opportunities to be searched for, then the search sponsorship process 140 returns to repeat steps 142-154. However, if it is determined in step 154 that there are no more sponsorship opportunities to be searched, then the search sponsorship process 140 exits at step 149.

Any process descriptions or blocks in flow charts should be understood as representing modules, segments, or portions of code which include one or more executable instructions for implementing specific logical functions or steps in the process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

1. A method for managing sponsorship opportunities by aligning a property with a potential sponsor embodied in a computer program product for execution on an instruction processing system, comprising a tangible storage medium readable by the instruction processing system and storing instructions for execution by the instruction processing system for performing the method comprising:
comparing sponsorship preferences with sponsorship properties;
determining which of the sponsorship properties match all the sponsorship preferences;
sorting the sponsorship properties into at least two groups, the first group including the sponsorship properties that match all the sponsorship preferences and a second group including the sponsorship properties that do not match all the sponsorship preferences;
creating a list of sponsorship properties included in the at least two groups; and
transmitting the list of sponsorship properties to a user device.

2. The method of claim 1, wherein the sorting the sponsorship properties further comprises:
sorting the second group by a number of sponsorship preferences that match sponsorship properties.

3. The method of claim 2, wherein the sorting the sponsorship properties further comprises:
sorting the second group by a decreasing number of sponsorship preferences that match sponsorship properties.

4. The method of claim 1, wherein the sorting the sponsorship properties further comprises:
sorting the sponsorship properties property category.

5. The method of claim 1, wherein the comparing sponsorship preferences further comprises:
using third party demographic data to match the sponsorship preferences to the sponsorship properties.

6. The method of claim 1, wherein the sponsorship properties are stored in a computer readable medium prior to the comparison of the sponsorship preferences with the sponsorship properties.

7. The method of claim 1, wherein the sponsorship preferences is selected from the group consisting of brand demographics data and sponsorship objectives.

8. The method of claim 7, wherein the brand demographics data is selected from the group consisting of gender, age, income, occupation, education and ethnicity.

9. The method of claim 7, wherein the sponsorship objectives is selected from the group consisting of sponsorship objectives, geography, seasonality, sponsorship level desired, brand category, product category and sponsorship budget range.

10. The method of claim 1, wherein the list is transmitted over a network to a user device.

11. A computer program product for providing an offer in a specific location, the computer program product comprising:
a tangible storage medium readable by a computer system and storing instructions for execution by the computer system for performing a method comprising:
comparing sponsorship preferences with sponsorship properties;
determining which of the sponsorship properties match all the sponsorship preferences;
sorting the sponsorship properties into at least two groups, the first group including the sponsorship properties that match all the sponsorship preferences and a second group including the sponsorship properties that do not match all the sponsorship preferences;
creating a list of sponsorship properties included in the at least two groups; and
transmitting the list of sponsorship properties to a user device.

12. The computer program product of claim 11, further comprising:
sorting the second group by a number of sponsorship preferences that match sponsorship properties.

13. The computer program product of claim 12, further comprising:
sorting the second group by a decreasing number of sponsorship preferences that match sponsorship properties.

14. The computer program product of claim 11, further comprising:
sorting the sponsorship properties property category.

15. The computer program product of claim 11, further comprising:
using demographic data to match the sponsorship preferences to the sponsorship properties.

16. The computer program product of claim 11, further comprising:
storing the sponsorship properties in a computer readable medium prior to the comparison of the sponsorship preferences with the sponsorship properties.

17. The computer program product of claim 11, wherein the sponsorship preferences is selected from the group consisting of brand demographics data and sponsorship objectives.

18. The computer program product of claim 17, wherein the brand demographics data is selected from the group consisting of gender, age, income, occupation, education and ethnicity.

19. The computer program product of claim 17, wherein the sponsorship objectives is selected from the group consisting of sponsorship objectives, geography, seasonality, sponsorship level desired, brand category, product category and sponsorship budget range.

20. The computer program product of claim 11, wherein the list is transmitted over a network to a user device.
